(19) United States
(12) Patent Application Publication
(10) Pub. No.: US 2024/0021058 A1
(43) Pub. Date: Jan. 18, 2024

(54) IDENTIFICATION INFORMATION-CALCULATING TYPE ELECTROMAGNETIC WAVE TRANSMISSION/RECEPTION-BASED INTRUSION SURVEILLANCE SYSTEM

(71) Applicant: E2 SYSTEM INC., Gyeongsangnam-do (KR)

(72) Inventor: Yun Doh HWANG, Gyeongsangnam-do (KR)

(73) Assignee: E2 SYSTEM INC., Gyeongsangnam-do (KR)

(21) Appl. No.: 18/036,659

(22) PCT Filed: Aug. 30, 2021
(86) PCT No.: PCT/KR2021/011622

§ 371 Date: May 12, 2023

(30) Foreign Application Priority Data
Nov. 12, 2020 (KR) 10-2020-0150603

(51) Int. Cl. G08B 13/24; G01S 13/88

(52) U.S. Cl. CPC G08B 13/24; G01S 13/886

(57) ABSTRACT

An identification information-calculating type electromagnetic wave transmission/reception-based intrusion surveillance system is proposed. The system is provided to detect an external intrusion by transmitting and receiving an electromagnetic wave signal between an electromagnetic wave signal transmission module and an electromagnetic wave signal reception module, which are installed to face with each other while forming a set in an access surveillance area. The system may prevent security loopholes from occurring caused by leakage of a frequency of the electromagnetic wave signal to an intruder or use of an electromagnetic wave signal of a similar frequency and perform accurate and precise intrusion detection by providing a structure that determines whether an external intrusion occurs according to whether identification information matches when the electromagnetic wave signal is transmitted and received in a transmission module and reception module that respectively perform generating an intrusion detection electromagnetic wave signal and sharing the corresponding identification information.

### TECHNICAL FIELD

The present disclosure relates to an identification information-calculating type electromagnetic wave transmission/reception-based intrusion surveillance system configured to detect an external intrusion by transmitting and receiving a specific frequency electromagnetic wave signal (i.e., an infrared signal, etc.) between an electromagnetic wave signal transmission module and an electromagnetic wave signal reception module, which are installed to face each other while forming a set in an access surveillance area and, more particularly, to an identification information-calculating type electromagnetic wave transmission/reception-based intrusion surveillance system that may prevent security loopholes from occurring caused by leakage of a frequency of an electromagnetic wave signal to an intruder or use of an electromagnetic wave signal of a similar frequency and perform accurate and precise intrusion detection by providing a structure that determines whether an external intrusion occurs or not according to whether identification information matches or not when the electromagnetic wave signal is transmitted and received in a transmission module and reception module that respectively perform generating an intrusion detection electromagnetic wave signal provided with the identification information other than frequency and sharing the corresponding identification information, and at the same time, the system may promote improvement of detection accuracy/precision and increase of detection stability even with a surveillance system having a simplified configuration by using, as the identification information, an identification binary number realized by an electromagnetic wave flash (representing 0 and 1) and the number of flashes (representing the number of binary digits).

### BACKGROUND ART

Various intrusion surveillance systems have been developed and used for a purpose of controlling access to major national institutions, industrial facilities, and other various facilities and detecting intrusion for protection of animals and livestock, or for a purpose of detecting intrusion through lightweight walls, windows, and doors. In a case of an infrared intrusion surveillance system that has an infrared beam emitter and receiver installed therein and detects intrusion by determining whether infrared beams are blocked or not, there occurs a problem that interference between the infrared beams and interference due to external light, noise, etc. are generated, causing poor detection performance. In addition, in order to prevent malfunctions caused by misalignment of optical axes of the infrared beams between the light emitter and the light receiver when the infrared intrusion surveillance system is installed, there occurs inconvenience for workers who have to perform tasks of checking output voltages of the light receiver one by one and matching the optical axes of the light emitter and the light receiver with each other, causing problems with difficulties of installation and maintenance.

Meanwhile, in a case where an infrared signal having the same frequency as or a higher frequency than that of an infrared signal used in the corresponding system is emitted from the outside, the conventional infrared intrusion surveillance system is unable to maintain security. In addition, since a frequency of the infrared signal is required to be different for each system implementing company or system installation location, there are many problems that the frequency of the infrared signal should be managed for each system implementing company or system installation location, and so on.

### DISCLOSURE

### Technical Problem

Accordingly, the present disclosure is devised to solve such a problem of such conventional technology, and an objective of the present disclosure is to provide a new type of an identification information-calculating type electromagnetic wave transmission/reception-based intrusion surveillance system that may prevent security loopholes from occurring caused by leakage of a frequency of an electromagnetic wave signal to an intruder or use of an electromagnetic wave signal of a similar frequency and perform accurate and precise intrusion detection by providing a structure that determines whether an external intrusion occurs Or not according to whether to match identification information of the intrusion detection electromagnetic wave signal, which is the intrusion detection electromagnetic wave signal (i.e., the intrusion detection infrared signal, etc.) having the identification information other than frequency and generated and transmitted by the electromagnetic wave signal transmission module and is the electromagnetic wave signal (i.e., the infrared signal, etc.) received by an electromagnetic signal reception module sharing the corresponding identification information.

In particular, another objective of the present disclosure is to provide a new type of identification information-calculating type electromagnetic wave transmission/reception-based intrusion surveillance system that may promote improvement of detection accuracy/precision and increase of detection stability even with a surveillance system having a simplified configuration by using, as the identification information, an identification binary number realized by an electromagnetic wave flash (representing 0 and 1) of the specific frequency such as an infrared ray and the number of flashes (representing the number of binary digits).

### Technical Solution

According to features of the present disclosure for achieving the above objectives, the present disclosure provides an identification information-calculating type electromagnetic wave transmission/reception-based intrusion surveillance system, the system including: an electromagnetic wave signal transmission module 100 installed at a set point of an access surveillance area, and configured to generate and transmit an intrusion detection electromagnetic wave signal of a set frequency to a target point, so that the intrusion detection electromagnetic wave signal is set to have an output form including identification information other than frequency and setting information of the intrusion detection electromagnetic wave information is stored; an electromagnetic wave signal reception module 200 installed at the target point of the access surveillance area while being spaced apart from the electromagnetic wave signal transmission module 100 and forming a set with the electromagnetic wave signal transmission module 100, and configured to receive an electromagnetic wave signal transmitted from an outside, and determine whether the electromagnetic wave signal is received or not and whether the received electromagnetic wave signal matches the intrusion detection electromagnetic wave signal or not, so that a same intrusion detection electromagnetic wave signal is set as that of the electromagnetic wave signal transmission module 100, and the setting information of the intrusion detection electromagnetic wave signal is stored; and an intrusion alarm signal output module 300 configured to interwork with the electromagnetic wave signal reception module 200, and output an intrusion alarm signal generated by determining an intrusion occurrence due to the determination of a non-receipt of the electromagnetic wave signal and the determination of a mismatch between the received electromagnetic wave signal and the intrusion detection electromagnetic wave signal.

In such an identification information-calculating type electromagnetic wave transmission/reception-based intrusion surveillance system according to the present disclosure, the identification information of the intrusion detection electromagnetic wave signal may be an identification binary number, one intrusion detection electromagnetic wave signal may be realized in an output form in which an electromagnetic wave flashes for a set number of times during a set unit signal output time, each electromagnetic wave flash may express 0 and 1 of the identification binary number, and the number of flashes of the electromagnetic wave may express the number of binary digits of the identification binary number.

In such an identification information-calculating type electromagnetic wave transmission/reception-based intrusion surveillance system according to the present disclosure, the electromagnetic wave signal transmission module 100 may be configured to include: a transmission-side DIP switch 110 to which an initial setting signal for generating the identification binary number is input by a user in an initial setting mode; a transmission-side controller 120 connected to the transmission-side dip switch 110 to receive the initial setting signal while generating an identification binary number table corresponding to the initial setting signal in the initial setting mode and configured to generate a signal-transmitter control signal for outputting the intrusion detection electromagnetic wave signal according to the identification binary number table in an intrusion detection mode; a transmission-side memory 130 connected to the transmission-side controller 120 to receive and store the identification binary number table in the initial setting mode, and configured to delete the existing identification binary number table and store only a new identification binary number table when the new identification binary number table is transmitted as of a present time point; and a signal transmitter 140 configured to receive the signal-transmitter control signal from the transmission-side controller 120 and output the intrusion detection electromagnetic wave signal in the intrusion detection mode.

In such an identification information-calculating type electromagnetic wave transmission/reception-based intrusion surveillance system according to the present disclosure, the electromagnetic wave signal reception module 200 may be configured to include: a signal receiver 210 configured to receive the electromagnetic wave signal transmitted from the outside in the intrusion detection mode; a reception-side dip switch 220 to which the initial setting signal for generating a same identification binary number as that of the electromagnetic wave signal transmission module 100 is input by the user in the initial setting mode; a reception-side controller 230 connected to the reception-side dip switch 220 to receive the initial setting signal while generating the identification binary number table corresponding to the initial setting signal in the initial setting mode, and configured to determine whether the electromagnetic wave signal is received or not and whether the received electromagnetic wave signal matches the intrusion detection electromagnetic wave signal or not by comparing the received electromagnetic wave signal with the intrusion detection electromagnetic wave signal according to the identification binary number table in the intrusion detection mode, and determine the intrusion occurrence when the determination of the non-receipt of the electromagnetic wave signal and the determination of the mismatch between the received electromagnetic wave signal and the intrusion detection electromagnetic wave signal, so as to generate and transmit the intrusion alarm signal to the output module 300; and a reception-side memory 240 connected to the reception-side controller 230 to receive and store the identification binary number table in the initial setting mode, and configured to delete the existing identification binary number table and store only the new identification binary number table when the new identification binary number table is transmitted as of the present time point.

In such an identification information-calculating type electromagnetic wave transmission/reception-based intrusion surveillance system according to the present disclosure, the electromagnetic wave signal transmission module 100 and the electromagnetic wave signal reception module 200 causes a plurality of sets of signal transmitters 140 and signal receivers 210 to be arranged in respective columns, and the reception-side controller 230 of the electromagnetic wave signal reception module 200 may determine each intruder access time point according to a chronological order of intrusion occurrence determination time points according to reception of the electromagnetic wave signal at each signal receiver 210.

### Advantageous Effects

According to the identification information-calculating type electromagnetic wave transmission/reception-based intrusion surveillance system in accordance with the present disclosure, there are effects that may prevent security loopholes from occurring caused by leakage of a frequency of an electromagnetic wave signal to an intruder or use of an electromagnetic wave signal of a similar frequency and perform accurate and precise intrusion detection by providing a structure that determines whether an external intrusion occurs or not according to whether identification information matches or not when the electromagnetic wave signal is transmitted and received in the electromagnetic wave signal transmission module 100 and the electromagnetic wave signal reception module 200 that respectively perform generating an intrusion detection electromagnetic wave signal provided with the identification information other than frequency and sharing the corresponding identification information, and at the same time, the system may promote improvement of detection accuracy/precision and increase of detection stability even with a surveillance system having a simplified configuration by using, as the identification information, an identification binary number realized by a specific frequency electromagnetic wave flash (representing 0 and 1) and the number of flashes (representing the number of binary digits).

### DESCRIPTION OF DRAWINGS

FIG. 1 is a block diagram illustrating a fundamental configuration of an identification information-calculating type electromagnetic wave transmission/reception-based intrusion surveillance system according to an exemplary embodiment of the present disclosure.

FIG. 2 is a view illustrating a process of generating an intrusion detection electromagnetic wave signal according to the exemplary embodiment of the present disclosure.

FIG. 3 is a configuration block diagram illustrating an electromagnetic wave signal transmission module according to the exemplary embodiment of the present disclosure.

FIG. 4 is a configuration block diagram illustrating an electromagnetic wave signal reception module according to the exemplary embodiment of the present disclosure.

FIG. 5 is a view illustrating an operation process of the electromagnetic wave signal transmission module according to the exemplary embodiment of the present disclosure.

FIG. 6 is a view illustrating an operation process of the electromagnetic wave signal reception module according to the exemplary embodiment of the present disclosure.

FIG. 7 is a view illustrating a process of determining an intruder access time point in the identification information-calculating type electromagnetic wave transmission/reception-based intrusion surveillance system according to the exemplary embodiment of the present disclosure, the system having a plurality of sets of signal transmitters and signal receivers.

### BEST MODE

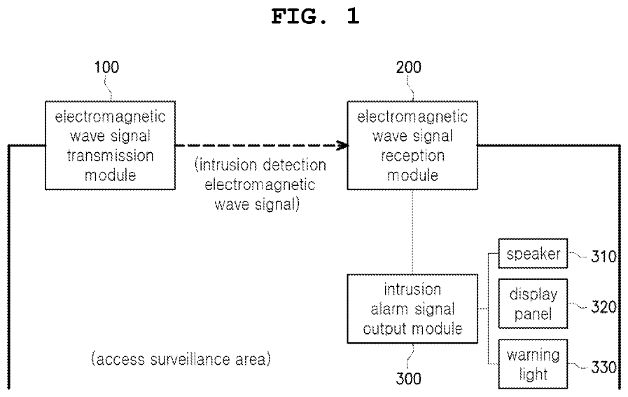

Hereinafter, an exemplary embodiment of the present disclosure will be described in detail based on the accompanying FIGS. 1 to 7. Meanwhile, in the drawings and detailed description, illustrations and references to configurations and operations that can be easily understood by those skilled in the art are simplified or omitted. In particular, detailed descriptions and illustrations of specific technical configurations and actions of elements not directly related to the technical features of the present disclosure are omitted in the drawings and detailed description, and only the technical configurations related to the present disclosure are briefly shown or described.

According to the exemplary embodiment of the present disclosure, as shown in FIG. 1, the identification information-calculating type electromagnetic wave transmission/reception-based intrusion surveillance system 1 is configured to include an electromagnetic wave signal transmission module 100, an electromagnetic wave signal reception module 200, and an intrusion alarm signal output module 300, and is for detecting external intrusion by transmitting and receiving an electromagnetic wave signal between the electromagnetic wave signal transmission module 100 and the electromagnetic wave signal reception module 200, which are installed to face each other while forming a set in an access surveillance area. An infrared signal may be used as the electromagnetic wave signal, but is not limited thereto and electromagnetic wave signals of various frequencies may be used.

The electromagnetic wave signal transmission module 100 is installed at a set point in the access surveillance area, and generates an intrusion detection electromagnetic wave signal at a set frequency and transmits the electromagnetic wave signal to a target point. Here, the intrusion detection electromagnetic wave signal is set to have an output form including identification information other than frequency. Setting information of the intrusion detection electromagnetic wave signal is stored in the electromagnetic wave signal transmission module 100 so as to enable iterative generation and transmission of intrusion detection electromagnetic wave signals.

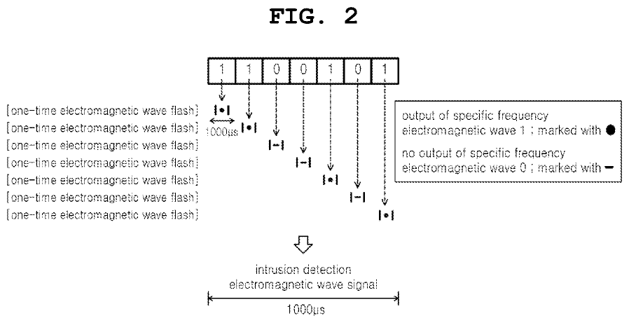

In particular, as illustrated in FIG. 2, the identification information of the intrusion detection electromagnetic wave signal according to the exemplary embodiment of the present disclosure is organized by using an identification binary number. The identification binary number may be directly input through an input device such as a DIP switch, or may be input as decimal numerals and then converted into the identification binary number by a controller or the like.

In addition, one intrusion detection electromagnetic wave signal is realized in a form of an output in which an electromagnetic wave signal, such as an infrared ray, flashes for a set number of times during a set unit signal output time. The electromagnetic wave flash expresses 0 and 1 of an identification binary number, and the number of times that the electromagnetic wave flashes expresses the number of binary digits of the identification binary number.

The expression of 0 and 1 by one-time electromagnetic wave flash, which is one binary digit of an identification binary number, is carried out based on whether an infrared ray is output or not for a very short unit time (e.g., 100 μs). That is, in a case where output of an electromagnetic wave is set to 1 and non-output of an electromagnetic wave is set to 0, it is considered that 1 is expressed when the electromagnetic wave is output during the time interval of 100 μs and 0 is expressed when no electromagnetic wave is output during the time interval of 100 μs.

In addition, one intrusion detection electromagnetic wave signal, which is identified as the entire identification binary number (e.g., 1100101), is realized by an electromagnetic wave flash operation of the set number of times, the operation being performed for a unit signal output time (e.g., 1000 μs) longer than the unit time for expressing one binary digit of the identification binary number.

Meanwhile, the electromagnetic wave signal transmission module 100 may configure the identification information of the intrusion detection electromagnetic wave signal to be composed of a single identification binary number table or a plurality of identification binary number tables generated by a set number generation formula.

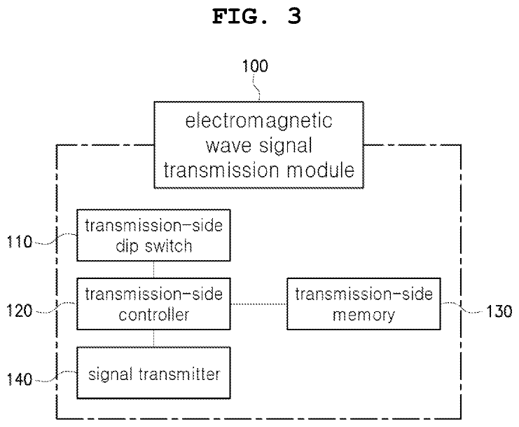

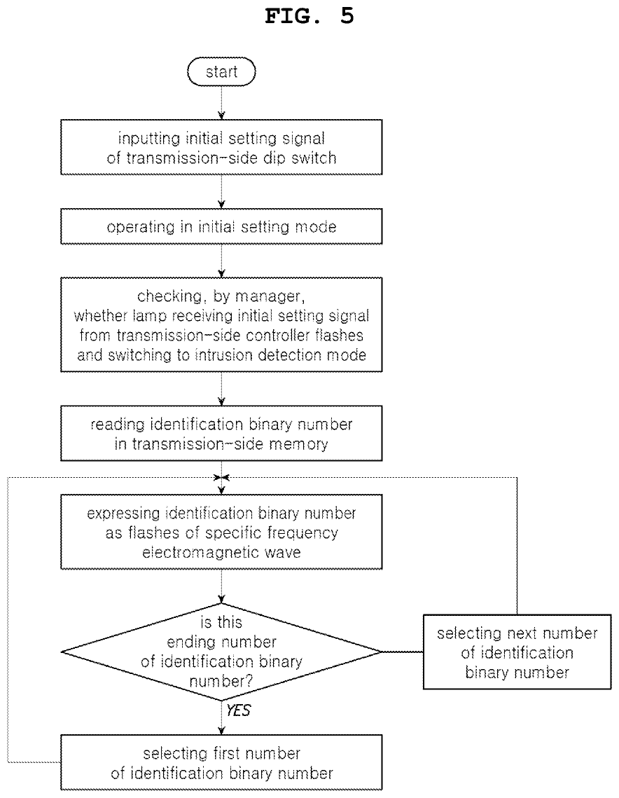

As shown in FIG. 3, the electromagnetic wave signal transmission module 100 according to the exemplary embodiment of the present disclosure is configured to include a transmission-side DIP switch 110, a transmission-side controller 120, a transmission-side memory 130, and a signal transmitter 140, and may operate as shown in FIG. 5.

The transmission-side DIP switch 110 is connected to the transmission-side controller 120, and an initial setting signal for generating an identification binary number is input by a user in an initial setting mode. Such a transmission-side dip switch 110 may be integrally formed on a main board constituting the transmission-side controller 120.

In the initial setting mode, the transmission-side controller 120 is connected to the transmission-side dip switch 110 to receive the initial setting signal while generating an identification binary number table corresponding to the initial setting signal. In addition, in an intrusion detection mode, a signal-transmitter control signal for outputting an intrusion detection electromagnetic wave signal according to the identification binary number table is generated and transmitted to the signal transmitter 140.

In the initial setting mode, the transmission-side memory 130 is connected to the transmission-side controller 120 to receive and store the identification binary number table. Here, when a new identification binary number table is transmitted as of a present time point, the transmission-side memory 130 deletes the existing identification binary number table and stores only the new identification binary number table.

In the intrusion detection mode, the signal transmitter 140 receives the signal-transmitter control signal from the transmission-side controller 120 and outputs an intrusion detection electromagnetic wave signal.

The electromagnetic wave signal reception module 200 forms a set with the electromagnetic wave signal transmission module 100, and is installed at a target point in an access surveillance area by being spaced apart from the electromagnetic wave signal transmission module 100. Such an electromagnetic wave signal reception module 200 receives an electromagnetic wave signal transmitted from the outside. In particular, the electromagnetic wave signal reception module 200 according to the exemplary embodiment of the present disclosure determines whether the electromagnetic wave signal is received or not and whether the received electromagnetic wave signal matches the intrusion detection electromagnetic wave signal or not. To this end, the electromagnetic wave signal reception module 200 sets the same intrusion detection electromagnetic wave signal as that of the electromagnetic wave signal transmission module 100, and stores the setting information of the intrusion detection electromagnetic wave signal.

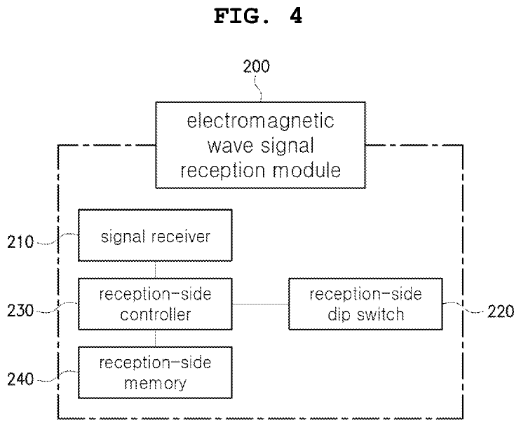

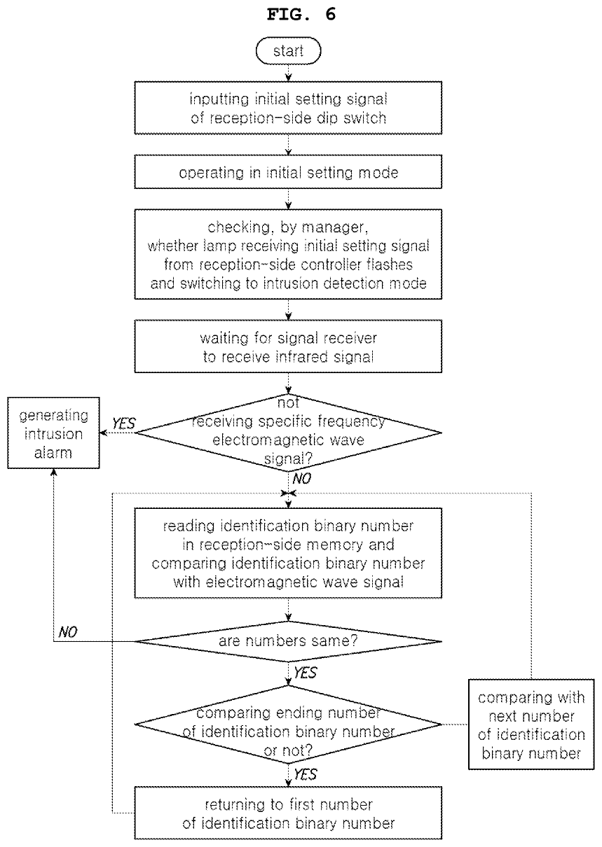

To this end, the electromagnetic wave signal reception module 200 according to the exemplary embodiment of the present disclosure is configured to include a signal receiver 210, a reception-side dip switch 220, a reception-side controller 230, and a reception-side memory 240 as shown in FIG. 4, and may operate as shown in FIG. 6.

In the intrusion detection mode, the signal receiver 210 receives the electromagnetic wave signal transmitted from the outside and transmits the electromagnetic wave signal to the reception-side controller 230.

The reception-side dip switch 220 is connected to the reception-side controller 230, and in the initial setting mode, the initial setting signal for generating the same identification binary number as that of the electromagnetic wave signal transmission module 100 is input by the user. Such a reception-side dip switch 220 may be integrally provided on a main board constituting the transmission-side controller 230.

The reception-side controller 230 is connected to the reception-side dip switch 220 in the initial setting mode to receive the initial setting signal while generating an identification binary number table corresponding to the initial setting signal. In addition, in the intrusion detection mode, 1) by determining whether the electromagnetic wave signal is received by the signal receiver 210 or not, the reception-side controller 230 determines that an intrusion has occurred when the electromagnetic wave signal is not received, so as to generate and transmit an intrusion alarm signal to the intrusion alarm signal output module 300. In addition, in the intrusion detection mode, 2) when the electromagnetic wave signal is received by the signal receiver 210, the reception-side controller 230 determines whether the received electromagnetic wave signal matches the intrusion detection electromagnetic wave signal or not by comparing the electromagnetic wave signal received by the signal receiver 210 with the intrusion detection electromagnetic wave signal according to the identification binary number table. In this case, when the received electromagnetic wave signal does not match the intrusion detection electromagnetic wave signal, the reception-side controller 230 determines that an intrusion has occurred, and generates and transmits an intrusion alarm signal to the intrusion alarm signal output module 300.

In the initial setting mode, the reception-side memory 240 is connected to the reception-side controller 230 to receive and store the identification binary number table. Here, when a new identification binary number table is transmitted as of a present time point, the reception-side memory 240 deletes the existing identification binary number table and stores only the new identification binary number table.

The intrusion alarm signal output module 300 is interworked with the electromagnetic wave signal reception module 200, and outputs an intrusion alarm signal generated by determining the intrusion occurrence due to the determination of the non-receipt of an electromagnetic wave signal and the determination of the mismatch between the received electromagnetic wave signal and the intrusion detection electromagnetic wave signal. The intrusion alarm signal may be realized as an alarm output sound, an alarm output message, an alarm output light, etc., and correspondingly, the intrusion alarm signal output module 300 may be configured with a speaker 310, a display panel 320, a warning light 330, etc.

Meanwhile, the identification information-calculating type electromagnetic wave transmission/reception-based intrusion surveillance system 1 according to the present disclosure may be provided with a plurality of sets each composed of the signal transmitter 140 of the electromagnetic wave signal transmission module 100 and the signal receiver 210 of the electromagnetic wave signal reception module 200, and a plurality of signal transmitters 140 is arranged in a column, and correspondingly, a plurality of signal receivers 210 is also arranged in a column, so as to correspond one-to-one with each other.

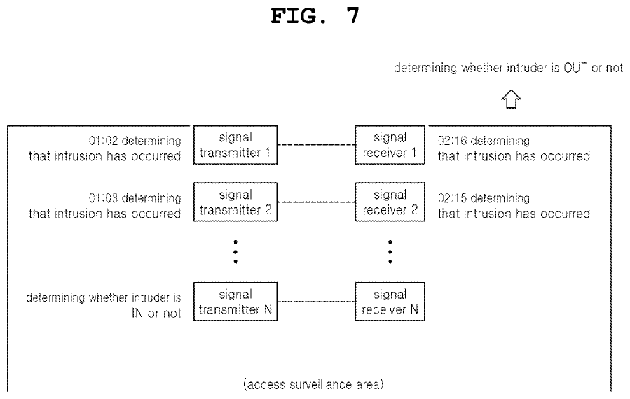

In this way, as shown in FIG. 7, the reception-side controller 230 of the electromagnetic wave signal reception module 200 may determine each intrude access time point according to a chronological order of intrusion occurrence determination time points based on the reception of the electromagnetic wave signals by the signal receiver 210.

The identification information-calculating type electromagnetic wave transmission/reception-based intrusion surveillance system 1 configured as described above may prevent security loopholes from occurring caused by leakage of a frequency of an electromagnetic wave signal to an intruder Or use of an electromagnetic wave signal of a similar frequency and perform accurate and precise intrusion detection by providing a structure that determines whether an external intrusion occurs or not according to whether identification information matches or not when the electromagnetic wave signal is transmitted and received in the electromagnetic wave signal transmission module 100 and electromagnetic wave signal reception module 200 that respectively perform generating an intrusion detection electromagnetic wave signal provided with the identification information other than frequency and sharing the corresponding identification information, and at the same time, the system may promote improvement of detection accuracy/precision and increase of detection stability even with a surveillance system having a simplified configuration by using, as the identification information, an identification binary number realized by a specific frequency electromagnetic wave flash (representing 0 and 1) and the number of flashes (representing the number of binary digits).

Although identification information-calculating type electromagnetic wave transmission/reception-based intrusion surveillance system according to the exemplary embodiment of the present disclosure as described above is shown according to the above description and drawings, this is only described as an example, and those skilled in the art will understand that various changes and modifications are possible within the scope without departing from the technical spirit of the present disclosure.

1. An identification information-calculating type electromagnetic wave transmission/reception-based intrusion surveillance system, the system comprising:
an electromagnetic wave signal transmission module (100) installed at a set point of an access surveillance area, and configured to generate and transmit an intrusion detection electromagnetic wave signal of a set frequency to a target point, so that the intrusion detection electromagnetic wave signal is set to have an output form comprising identification information other than frequency and setting information of the intrusion detection electromagnetic wave information is stored;
an electromagnetic wave signal reception module (200) installed at the target point of the access surveillance area while being spaced apart from the electromagnetic wave signal transmission module (100) and forming a set with the electromagnetic wave signal transmission module (100), and configured to receive an electromagnetic wave signal transmitted from an outside, and determine whether the electromagnetic wave signal is received or not and whether the received electromagnetic wave signal matches the intrusion detection electromagnetic wave signal or not, so that a same intrusion detection electromagnetic wave signal is set as that of the electromagnetic wave signal transmission module (100), and the setting information of the intrusion detection electromagnetic wave signal is stored; and
an intrusion alarm signal output module (300) configured to interwork with the electromagnetic wave signal reception module (200), and output an intrusion alarm signal generated by determining an intrusion occurrence due to the determination of a non-receipt of the electromagnetic wave signal and the determination of a mismatch between the received electromagnetic wave signal and the intrusion detection electromagnetic wave signal.

2. The system of claim 1, wherein the identification information of the intrusion detection electromagnetic wave signal is an identification binary number,
one intrusion detection electromagnetic wave signal is realized in an output form in which an electromagnetic wave flashes for a set number of times during a set unit signal output time,
each electromagnetic wave flash expresses 0 and 1 of the identification binary number, and
the number of flashes of the electromagnetic wave expresses the number of binary digits of the identification binary number.

3. The system of claim 2, wherein the electromagnetic wave signal transmission module (100) is configured to comprise:
a transmission-side DIP switch (110) to which an initial setting signal for generating the identification binary number is input by a user in an initial setting mode;
a transmission-side controller (120) connected to the transmission-side dip switch (110) to receive the initial setting signal while generating an identification binary number table corresponding to the initial setting signal in the initial setting mode and configured to generate a signal-transmitter control signal for outputting the intrusion detection electromagnetic wave signal according to the identification binary number table in an intrusion detection mode;
a transmission-side memory (130) connected to the transmission-side controller (120) to receive and store the identification binary number table in the initial setting mode, and configured to delete the existing identification binary number table and store only a new identification binary number table when the new identification binary number table is transmitted as of a present time point; and
a signal transmitter (140) configured to receive the signal-transmitter control signal from the transmission-side controller (120) and output the intrusion detection electromagnetic wave signal in the intrusion detection mode.

4. The system of claim 3, wherein the electromagnetic wave signal reception module (200) is configured to comprise:
a signal receiver (210) configured to receive the electromagnetic wave signal transmitted from the outside in the intrusion detection mode;
a reception-side dip switch (220) to which the initial setting signal for generating a same identification binary number as that of the electromagnetic wave signal transmission module (100) is input by the user in the initial setting mode;
a reception-side controller (230) connected to the reception-side dip switch (220) to receive the initial setting signal while generating the identification binary number table corresponding to the initial setting signal in the initial setting mode, and configured to determine whether the electromagnetic wave signal is received or not and whether the received electromagnetic wave signal matches the intrusion detection electromagnetic wave signal or not by comparing the received electromagnetic wave signal with the intrusion detection electromagnetic wave signal according to the identification binary number table in the intrusion detection mode, and determine the intrusion occurrence when the determination of the non-receipt of the electromagnetic wave signal and the determination of the mismatch between the received electromagnetic wave signal and the intrusion detection electromagnetic wave signal, so as to generate and transmit the intrusion alarm signal to the output module (300); and
a reception-side memory (240) connected to the reception-side controller (230) to receive and store the identification binary number table in the initial setting mode, and configured to delete the existing identification binary number table and store only the new identification binary number table when the new identification binary number table is transmitted as of the present time point.

5. The system of claim 4, wherein the electromagnetic wave signal transmission module (100) and the electromagnetic wave signal reception module (200) causes a plurality of sets of signal transmitters (140) and signal receivers (210) to be arranged in respective columns, and
the reception-side controller (230) of the electromagnetic wave signal reception module (200) determines each intruder access time point according to a chronological order of intrusion occurrence determination time points according to reception of the electromagnetic wave signal at each signal receiver (210).
